(19) United States
(12) Patent Application Publication
(10) Pub. No.: US 2003/0166815 A1
(43) Pub. Date: Sep. 4, 2003

(54) Methylpropane-1,3-diol-mono(meth)acrylate for producing coating materials, adhesives and sealing materials which can be hardened oxidatively and/or thermally

(76) Inventors: Hubert Baumgart, Munster (DE); Wilma Locken, Munster (DE); Heinz-Peter Rink, Munster (DE); Ulrike Rockrath, Senden (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/400,331

(22) Filed: Mar. 27, 2003

Related U.S. Application Data
(63) Continuation of application No. 09/830,440, filed on May 15, 2001, now abandoned.
Application No. 09/830,440 is a 371 of international application No. PCT/EP99/08037, filed on Oct. 22, 1999.

(30) Foreign Application Priority Data
Oct. 31, 1998 (DE) 198 50 210.9

(51) Int. Cl. C08F 120/10

(52) U.S. Cl. 526/323.2; 526/323.1; 527/314; 525/59; 525/502

(57) ABSTRACT

The use of methylpropane-1,3-diol mono(meth)-acrylate to prepare oxidatively and/or thermally curable coating compositions, adhesives, and sealing compounds.

### CROSS-REFERENCE TO RELATED APPLICATIONS

This application is a continuation of U.S. Ser. No. 09/830,440, filed May 15, 2001, now abandoned, which is a 371 National Stage Application of PCT/EP99/08037, filed on Oct. 22, 1999, which claims priority to DE 198 50 510.9, filed Oct. 31, 1998. U.S. Ser. No. 09/830,440 is incorporated herein by reference.

The present invention relates to the novel use of methylpropane-1,3-diol mono(meth)acrylate to prepare oxidatively and/or thermally curable coating compositions, adhesives, and sealing compounds. The present invention further relates to novel coating compositions, adhesives, and sealing compounds, especially novel coating compositions, which comprise homopolymers and/or copolymers of methylpropane-1,3-diol mono(meth)acrylate, in particular as binders. The present invention relates, furthermore, to novel scratch-resistant coatings, adhesive films, and seals, but especially to scratch-resistant coatings for the automobile sector.

In past years, great, progress has been made in developing acid-resistant and etch-resistant clearcoats for the OEM finishing of automobiles. More recently, there has been an increasing desire in the automobile industry and among its customers for scratch-resistant clearcoats which at the same time retain the level attained hitherto in terms of their other properties, if not indeed exceeding that level.

In the market there is likewise a desire for novel adhesives and sealing compounds which have an improved profile of properties.

The German patent DE-C-197 09 467 or the German laid-open specification DE-A-197 09 465 discloses thermally curable coating compositions based on hydroxyl-containing binders and crosslinking agents containing functional groups that are reactive with hydroxyl groups. After they have been cured, they have a storage modulus E′ in the rubber-elastic range of at least 10^{7.6} Pa and a loss factor tanδ at 20° C. of not more than 0.10, the storage modulus E′ and the loss factor having been measured by dynamic mechanical thermoanalysis on free films having a film thickness of 40±10 μm.

The coatings produced from these, especially the clearcoat and/or topcoats for automobile bodies, already have excellent scratch resistance and chemical resistance. Nevertheless, there is a desire in the market for further alternatives which with regard to specific applications, such as in combination with specific basecoat materials, are superior to the coating compositions known to date.

Furthermore, there is no knowledge of whether the known coating compositions may also be used as adhesives or sealing compounds.

Methylpropane-1,3-diol mono(meth)acrylate and its low molecular weight polymers are known from the German patent DE-A-32 34 045. The polymers are used to produce photosensitive compositions used for imagewise exposure. It is unknown whether they are suitable in addition for the preparation of thermally and/or oxidatively curable coating compositions, adhesives or sealing compounds.

It is an object of the present invention to find novel, thermally curable coating compositions, adhesives, and sealing compounds which allow the production of scratch-resistant coatings, adhesive films, and seals. The novel coating compositions, adhesives, and sealing compounds should at the same time possess good storage stability (at least 8 weeks on storage at 50° C.) and should lead to coatings, adhesive films, and seals which as well as high scratch resistance possess high chemical resistance, good moisture resistance, and effective polishability, so making them suitable for use in the furniture, industrial, and, in particular, automobile sectors. In particular, the coating compositions ought to be suitable as clearcoat material and/or topcoat material for producing a multicoat system, especially on automobile bodies. The cured coating compositions ought not least to exhibit good weathering resistance, good acid/base resistance, effective resistance to bird droppings and the like, high gloss, a good appearance, and also good adhesion to other coats.

A further object of the present invention was to find a novel, economically and technically valuable use for methylpropane-1,3-diol mono(meth)acrylate.

The invention accordingly provides the novel oxidatively and/or thermally curable coating compositions, adhesives, and sealing compounds which comprise at least one homopolymer (A) of methylpropane-1,3-diol mono(meth)acrylate and/or copolymer (A) of methylpropane-1,3-diol mono(meth)acrylate with at least one further monomer copolymerizable therewith.

The invention further provides the novel oxidatively and/or thermally curable coating compositions, adhesives, and sealing compounds which comprise

A) at least one homopolymer of methylpropane-1,3-diol mono(meth)acrylate and/or a copolymer of methylpropane-1,3-diol mono(meth)acrylate with at least one further monomer copolymerizable therewith, as binder, and

B) at least one crosslinking agent containing functional groups that are reactive with hydroxyl groups.

In the text below, these novel oxidatively and/or thermally curable coating compositions, adhesives, and sealing compounds are referred to for short collectively as the “coating compositions, adhesives, and sealing compounds of the invention”.

The invention additionally provides a novel process for preparing homopolymers of methylpropane-1,3-diol mono(meth)acrylate and/or copolymers of methylpropane-1,3-diol mono(meth)acrylate with at least one further monomer copolymerizable therewith.

In the text below, this novel process is referred to as the “process of the invention”.

The invention provides not least the novel pigmented and unpigmented coatings, adhesive films, and seals which can be produced with the aid of the novel oxidatively and/or thermally curable coating compositions, adhesives, and sealing compounds.

In the text below, the novel pigmented and unpigmented coatings, adhesive films, and seals are referred to for short as the “coatings, adhesive films, and seals of the invention”.

In the light of the prior art it was surprising and unforeseeable for the skilled worker that the object on which the present invention is based might be achieved with the aid of the inventive use of methylpropane-1,3-diol mono(meth)acrylate.

The key constituent of the coating compositions, adhesives, and sealing compounds of the invention are the homopolymers and/or copolymers (A) of methylpropane-1,3-diol mono(meth)acrylate, especially the copolymers (A) with copolymerizable monomers, that are intended for use in accordance with the invention.

Suitable copolymerizable monomers include all monofunctional and higher polyfunctional monomers that are customary and known in the field of plastics. In accordance with the invention it is of advantage to use monofunctional monomers, in order to prevent unwanted crosslinking or gelling of the copolymers during their preparation. In many cases, however, it may be of advantage to use monomers of higher functionality as well in minor amounts.

Examples of suitable monomers for use in accordance with the invention are

A1) olefins such as ethylene, propylene, but-1-ene, pent-1-ene, hex-1-ene, cyclohexene, cyclopentene, norbornene, butadiene, isoprene, cyclopentadiene or dicyclopentadiene,

A2) esters of (meth)acrylic acid that are substantially free from acid groups and hydroxyl groups, such as

(meth)acrylic alkyl or cycloalkyl esters having up to 20 carbon atoms in the alkyl radical, especially methyl, ethyl, propyl, n-butyl, sec-butyl, tert-butyl, hexyl, ethylhexyl, stearyl, and lauryl acrylate or methacrylate; or cycloaliphatic (meth)acrylic esters, especially cyclohexyl, isobornyl, dicyclopentadienyl, octahydro-4,7-methano-1H-indenemethanol or tert-butylcyclohexyl (meth)acrylate;

(meth)acrylic oxaalkyl or oxacycloalkyl esters such as ethyl triglycol (meth)acrylate and methoxyoligoglycol (meth)acrylate having a molecular weight Mn of preferably 550 or other ethoxylated and/or propoxylated, hydroxyl-free (meth)acrylic acid derivatives;

ethylene glycol, propylene glycol, diethylene glycol, dipropylene glycol, butylene glycol, pentane-1,5-diol, hexane-1,6-diol, octahydro-4,7-methano-1H-indenedimethanol or cyclohexane-1,2-, 1,3- or 1,4-diol di(meth)acrylate; or trimethylolpropane di- or tri(meth)acrylate or pentaerythritol di-, tri- or tetra(meth)acrylate;

A3) (meth)acrylamides such as (meth)acrylamide, N-methyl-, N,N-dimethyl-, N-ethyl-, N,N-diethyl-, N-propyl-, N,N-dipropyl, N-butyl-, N,N-dibutyl-, N-cyclohexyl- or N,N-cyclohexyl-methyl-(meth)acrylamide;

A4) monomers which carry at least one hydroxyl group per molecule and are substantially free from acid groups, such as

hydroxyalkyl esters of acrylic acid, methacrylic acid or another alpha,beta-ethylenically unsaturated carboxylic acids which are derived from an alkylene glycol which is esterified with the acid or are obtainable by reacting the acid with an alkylene oxide, especially hydroxyalkyl esters of acrylic acid, methacrylic acid, ethacrylic acid or crotonic acid in which the hydroxyalkyl group contains up to 20 carbon atoms, such as 2-hydroxyethyl, 2-hydroxypropyl, 3-hydroxypropyl, 3-hydroxybutyl, 4-hydroxybutyl, octahydro-4,7-methano-1H-indenedimethanol or methylpropanediol monoacrylate, monomethacrylate, monoethacrylate or monocrotonate; or reaction products of cyclic esters, such as epsilon-caprolactone, for example, and these hydroxyalkyl esters;

olefinically unsaturated alcohols such as allyl alcohol or polyols such as trimethylolpropane monoallyl or diallyl ether or pentaerythritol monoallyl, diallyl or triallyl ether;

A5) monomers carrying at least one acid group, preferably a carboxyl, sulfonic or phosphonic acid group, per molecule, especially acrylic acid, methacrylic acid, ethacrylic acid, crotonic acid, maleic acid, fumaric acid, itaconic acid, mono(meth)acryloyloxyethyl maleate, mono(meth)acryloyloxyethyl succinate or mono(meth)acryloyloxyethyl phthalate;

A6) monomers containing epoxide groups, such as the glycidyl ester of acrylic acid, methacrylic acid, ethacrylic acid, crotonic acid, maleic acid, fumaric acid or itaconic acid;

A7) vinylaromatic hydrocarbons, such as styrene, alpha-alkylstyrenes, especially alpha-methylstyrene, or vinyltoluene;

A8) nitriles such as acrylonitrile or methacrylonitrile;

A9) reaction products of the above-described monomers (A5) with the glycidyl ester of an alpha-branched monocarboxylic acid having from 5 to 18 carbon atoms per molecule, in particular the reaction product of acrylic and/or methacrylic acid with the glycidyl ester of Versatic acid;

A10) vinyl compounds such as vinyl chloride, vinyl fluoride, vinylidene dichloride, vinylidene difluoride; N-vinylpyrrolidone; vinyl ethers such as ethyl vinyl ether, n-propyl vinyl ether, isopropyl vinyl ether, n-butyl vinyl ether, isobutyl vinyl ether or vinyl cyclohexyl ether; vinyl esters such as vinyl acetate, vinyl propionate, vinyl butyrate, vinyl pivalate or the vinyl ester of 2-methyl-2-ethylheptanoic acid or vinyl esters of alpha-branched monocarboxylic acids having from 5 to 18 carbon atoms in the molecule that are obtained by reacting formic acid or carbon monoxide and water in the presence of a liquid, strongly acidic catalyst with propylene trimer, propylene tetramer or diisobutylene or with olefins which are cracking products of paraffinic hydrocarbons such as mineral oil fractions and which contain either branched or straight-chain acyclic and/or cycloaliphatic olefins;

A11) polysiloxane macromonomers which have a number-average molecular weight Mn of from 1 000 to 40 000, preferably from 2 000 to 20 000, with particular preference from 2 500 to 10 000, and in particular from 3 000 to 7 000, and contain on average from 0.5 to 2.5, preferably from 0.5 to 1.5, ethylenically unsaturated double bonds per molecule, as are described in DE-A-38 07 571 on pages 5 to 7, in DE-A-37 06 095 in columns 3 to 7, in EP-B-0 358 153 on pages 3 to 6, in U.S. Pat. No. 4,754,014 in columns 5 to 9, in DE-A 44 21 823 or in the international patent application WO 92/22615 on page 12 line 18 to page 18 line 10, or acryloxysilane-containing vinyl monomers, preparable by reacting hydroxy-functional silanes with epichlorohydrin and then reacting that reaction product with methacrylic acid and/or hydroxyalkyl esters of (meth)acrylic acid.

In accordance with the invention, accordingly, the monomers may be selected such that copolymers of any kind result from the copolymerization, such as polyolefins, polystyrenes, polybutadienes, polyisoprenes, polyvinyl chlorides, polyacrylonitriles, polyvinyl acetates or polyacrylates, for instance.

In accordance with the invention it is an advantage, however, to select the monomers such that the copolymerization results in binders (A) for the coating compositions, adhesives or sealing compounds of the invention. The sealing compounds, in addition to the binder(s) (A), further comprise at least one crosslinking agent (B) which with the binders (A) forms a three-dimensional thermoset network on heating.

Crosslinking reactions of this kind are customary and known in the fields of the coating compositions, adhesives, and sealing compounds, and are described, for example, in the article by M. Ooka and H. Ozawa, “Recent developments in crosslinking technology for coating resins” in Progress in Organic Coatings, Volume 23 (1994) , 325 to 338. The invention prefers the crosslinking reaction between hydroxyl groups and functional groups that are able to react with hydroxyl groups.

In accordance with the invention it is of advantage to select the monomers so as to give hydroxyl-containing polyacrylates. These polyacrylates, besides the methylpropane-1,3-diol mono(meth)acrylate for use in accordance with the invention, preferably contain the monomers (A2).

Furthermore, they may contain minor amounts of monomers (A1), (A3) and/or (A4) to (A11) as copolymerized units. The term “minor amount” in this context comprehends a monomer fraction which does not seriously influence, but instead advantageously varies, the advantageous profile of properties brought about by the methylpropane-1,3-diol mono(meth)acrylate for use in accordance with the invention.

In accordance with the invention, it is of very particular advantage to select the monomers so as to give hydroxyl-containing polyacrylates which have a OHN of from 40 to 240, preferably from 60 to 210, with very particular preference from 100 to 200, acid numbers of from 0 to 80, preferably from 0 to 50, glass transition temperatures of from −35 to +80° C., preferably from −20 to +40° C., and number-average molecular weight Mn of from 1 500 to 1 000 000, preferably from 1 500 to 30 000, with very particular preference from 1 500 to 5 000.

The glass transition temperature of the polyacrylate resins is determined by the nature and amount of the monomers used. The skilled worker may select the monomers with the aid of the following formula, which can be used to calculate approximately the glass transition temperatures of polyacrylate resins:

$$1 \text{/} Tg = {\sum }_{n = 1}^{n = x} {W}_{n} \text{/} {Tg}_{n} ; {\sum }_{n} {W}_{n} = 1$$

Tg=glass transition temperature of the polyacrylate resin

Wₙ=weight fraction of the nth monomer

Tgₙ=glass transition temperature of the homopolymer of the nth monomer

X=number of different monomers

Measures to control the molecular weight (e.g., selection of appropriate polymerization initiators, use of chain transfer agents, etc.) are part of the expert knowledge of the skilled worker and require no further elucidation here.

The inventive (co)polymerization of methylpropane-1,3-diol mono(meth)acrylate has no special features in terms of its methodology but instead takes place with the aid of the methods of continuous or batchwise homopolymerization or copolymerization, in bulk, solution, carbon dioxide or emulsion, under atmospheric pressure or superatmospheric pressure in stirred tanks, autoclaves, tube reactors or Taylor reactors, that are customary and known in the plastics field.

Examples of suitable (co)polymerization processes are described in the patents DE-A-197 09 465, DE-C-197 09 476, DE-A-28 48 906, DE-A-195 24 182, EP-A-0 554 783, WO 95/27742 and WO 82/02387.

In accordance with the invention, Taylor reactors are advantageous and are therefore used with preference for the process of the invention.

Taylor reactors, which serve to convert substances under the conditions of Taylor flow, are known. They consist substantially of two coaxial concentric cylinders of which the outer is fixed and the inner rotates. The reaction space is the volume formed by the gap between the cylinders. Increasing angular velocity ωᵢ of the inner cylinder is accompanied by a series of different flow patterns which are characterized by a dimensionless parameter, known as the Taylor number Ta. As well as the angular velocity of the stirrer, the Taylor number is also dependent on the kinematic viscosity ν of the fluid in the gap and on the geometric parameters, the external radius of the inner cylinder rᵢ, the internal radius of the outer cylinder rₒ, and the gap width d, the difference between the two radii, in accordance with the following formula:

Ta=ωᵢrᵢd ν⁻¹(d/rᵢ)^{1/2} (I)

where

d=rₒ−rᵢ.

At low angular velocity, the laminar Couette flow, a simple shear flow, develops. If the rotary speed of the inner cylinder is increased further, then, above a critical level, alternately contrarotating vortices (rotating in opposition) occur, with axes along the peripheral direction. These vortices, called Taylor vortices, are rotationally symmetric and have a diameter which is approximately the same size as the gap width. Two adjacent vortices form a vortex pair or vortex cell.

The basis of this behavior is the fact that, in the course of rotation of the inner cylinder with the outer cylinder at rest, the fluid particles that are near to the inner cylinder are subject to a greater centrifugal force than those at a greater distance from the inner cylinder. This difference in the acting centrifugal forces displaces the fluid particles from the inner to the outer cylinder. The centrifugal force acts counter to the viscosity force, since for the motion of the fluid particles it is necessary to overcome the friction. Any increase in the rotary speed is accompanied by an increase in the centrifugal force as well. The Taylor vortices are formed when the centrifugal force exceeds the stabilizing viscosity force.

In the case of Taylor flow with a low axial flow, each vortex pair passes through the gap, with only a low level of mass transfer between adjacent vortex pairs. Mixing within such vortex pairs is very high, whereas axial mixing beyond the pair boundaries is very low. A vortex pair may therefore be regarded as a stirred tank in which there is thorough mixing. Accordingly, the flow system behaves as an ideal flow tube in that the vortex pairs pass through the gap with constant residence time, like ideal stirred tanks.

Of advantage in accordance with the invention here are Taylor reactors having an external reactor wall located within which there is a concentrically or eccentrically disposed rotor, a reactor floor, and a reactor lid, which together define the annular reactor volume, at least one means for metered addition of reactants, and a means for the discharge of product, where the reactor wall and/or the rotor are or is geometrically designed in such a way that the conditions for Taylor flow are met over substantially the entire reactor length in the reactor volume, i.e., in such a way that the annular gap broadens in the direction of flow traversal.

As (co)polymerization initiators it is preferred to use initiators which form free radicals. The nature and amount of initiators are customarily chosen such that, at the polymerization temperature during the feed phase, the supply of radicals remains as constant as possible. Examples of initiators which can be used include: dialkyl peroxides, e.g., di-tert-butyl peroxide and dicumyl peroxide, hydroperoxides, e.g., cumene hydroperoxide and tert-butyl hydroperoxide, peresters, e.g., tert-butyl perbenzoate, tert-butyl perpivalate, tert-butyl per-3,5,5-trimethylhexanoate, and tert-butyl per-2-ethylhexanoate, or bisazo compounds such as azobisisobutyronitrile.

The polymerization conditions (reaction temperature, feed time of the monomer mixture and polymerization initiators, possible use of molecular weight regulators, e.g., mercaptans, thioglycolic esters, alpha-diphenylethene, compounds containing nitroxyl radical groups, or hydrogen chloride) are selected such that, in particular, the polyacrylates which are used and prepared with particular preference in accordance with the invention have a number-average molecular weight as stated above (determined by gel permeation chromatography using polystyrene as calibrating substance). The acid number may be adjusted by the skilled worker using appropriate amounts of component (A5). Similar comments apply to the adjustment of the hydroxyl number and the epoxide number; they may be controlled by way of the amount of component (A4) and (A6) used, respectively.

For the process of the invention it is of advantage to conduct the (co)polymerization in hydroxyl-containing reactive diluents for thermally curable coating compositions, adhesives, and sealing compounds.

Suitable reactive diluents as reaction medium in accordance with the invention are all those which are incorporated into the binder (A) in the course of the known crosslinking reactions between the hydroxyl groups and the functional groups of the crosslinking agent (B) that are reactive with hydroxyl groups, and which do not hinder, let alone prevent, the homopolymerization or copolymerization of methylpropane-1,3-diol mono(meth)acrylate. The skilled worker is therefore able to select the reactive diluents that are appropriate in each case using his or her general knowledge of the art, with the assistance if desired of simple preliminary experiments.

Examples of suitable reactive diluents for use in accordance with the invention are oligomeric polyols, which are obtainable from oligomeric intermediates, themselves obtained by metathesis reactions of acyclic monoolefins and cyclic monoolefins, by hydroformylation and subsequent hydrogenation; examples of suitable cyclic monoolefins are cyclobutene, cyclopentene, cyclohexene, cyclooctene, cycloheptene, norbornene or 7-oxanorbornene; examples of suitable acyclic monoolefins are present in hydrocarbon mixtures obtained in petroleum processing by cracking (C₅ cut); examples of suitable oligomeric polyols for use in accordance with the invention have a hydroxyl number (OHN) of from 200 to 450, a number-average molecular weight Mn of from 400 to 1 000, and a mass-average molecular weight Mw of from 600 to 1 100; further examples of suitable polyols for use in accordance with the invention are branched, cyclic and/or acyclic C₉-C₁₆ alkanes that are functionalized with at least two hydroxyl groups, especially diethyloctanediols.

Further examples of suitable polyols for use in accordance with the invention are hyperbranched compounds having a tetrafunctional central group, derived from ditrimethylolpropane, diglycerol, ditrimethylolethane, pentaerythritol, tetrakis-(2-hydroxyethyl)methane, tetrakis(3-hydroxypropyl)-methane or 2,2-bishydroxymethyl-1,4-butanediol (homo-pentaerythritol). These reactive diluents may be prepared in accordance with the customary and known methods of preparing hyperbranched and dendrimeric compounds. Appropriate synthesis methods are described, for example, in the patents WO 93/17060 and WO 96/12754 or in the book by G. R. Newkome, C. N. Moorefield, and F. Vögtle, “Dendritic Molecules, Concepts, Syntheses, Perspectives”, VCH, Weinheim, New York, 1996.

Besides the binders (A) for use in accordance with the invention, the coating compositions, adhesives, and sealing compounds of the invention may include minor amounts of further homopolymers or copolymers. In the context of the present invention, the term “minor amounts” indicates that the fractions to be used should be only those which do not deleteriously alter but instead advantageously vary, or further improve, the advantageous profile of properties of the coating compositions, adhesives, and sealing compounds of the invention, as is brought about by the binders (A) for use in accordance with the invention.

Examples of suitable homopolymers or copolymers which may be added to the coating compositions, adhesives, and sealing compounds of the invention are customary and known polyacrylates, polyesters, polyurethanes, acrylated polyurethanes, acrylated polyesters, polylactones, polycarbonates, polyethers or (meth)acrylatediols.

Suitable polyacrylates are sold, for example, under the brand name Joncryl^{R}, such as Joncryl^{R} SCX912 and 922.5, for instance.

Suitable polyester resins and/or alkyd resins are described, for example, in Ullmanns Encyklopädie der technischen Chemie, third edition, volume 14, Urban & Schwarzenberg, Munich, Berlin 1963, pages 80 to 89 and pages 99 to 105, or in the following books: Résines Alkydes-Polyesters by J. Bourry, Paris, Dunod 1952, Alkyd Resins by C. R. Martens, Reinhold Publishing Corporation, New York 1961, and Alkyd Resin Technology by T. C. Patton, Interscience Publishers 1962.

Examples of suitable polyurethane resins are the resins described in the patents EP-A-0 708 788, DE-A-44 01 544, and DE-A-195 34 361.

As a further key constituent the coating compositions, adhesives, and sealing compounds of the invention comprise the crosslinking agents (B).

In this context it is possible to configure the coating compositions, adhesives, and sealing compounds of the invention as one-component systems or else as multicomponent systems. Such systems differ essentially in the nature of the crosslinking agent used. In both cases, suitable crosslinking agents include all those which react with the hydroxyl groups of the binders (A) under the curing conditions. In the case of the multicomponent systems, however, the crosslinking agents suitable for this purpose must, owing to its high reactivity, be stored separately from the other constituents until shortly before it is used.

Examples of suitable crosslinking agents are amino resins, beta-hydroxyalkylamides, resins or compounds containing siloxane groups, resins or compounds containing, anhydride groups, resins or compounds containing carboxyl groups, blocked and unblocked polyisocyanates or alkoxycarbonylamino-triazines, but especially blocked polyisocyanates or tris(alkoxycarbonylamino)triazines.

In both one-component and multicomponent systems, blocked polyisocyanates or a mixture of blocked polyisocyanates may be used.

The blocked polyisocyanates which may be used are preferably designed so that they contain not only isocyanate groups blocked with a blocking agent (Z1) but also isocyanate groups blocked a with blocking agent (Z2), the blocking agent (Z1) being a dialkyl malonate or a mixture of dialkyl malonates, the blocking agent (Z2) being a blocking agent other than (Z1) and containing active methylene groups, being an oxime, or being a mixture of these blocking agents, and the ratio of equivalents between the isocyanate groups blocked with (Z1) and the isocyanate groups blocked with (Z2) being between 1.0:1.0 and 9.0:1.0, preferably between 8.0:2.0 and 6.0:4.0, with particular preference between 7.5:2.5 and 6.5:3.5.

Further suitable blocking agents include dimethylpyrazole and/or substituted triazoles.

A pblyisocyanate or a mixture of polyisocyanates is reacted conventionally with a mixture of the blocking agents (Z1) and (Z2), the mixture of the blocking agents (Z1) and (Z2) comprising the blocking agents (Z1) and (Z2) in a molar ratio of between 1.0:1.0 and 9.0:1.0, preferably between 8.0:2.0 and 6.0:4.0, with particular preference between 7.5:2.5 and 6.5:3.5.

The polyisocyanate, or mixture of polyisocyanates, may be reacted with the mixture of the blocking agents (Z1) and (Z2) to such an extent that isocyanate groups are no longer detectable. In practice, this may necessitate the use of very large excesses of blocking agents and/or very long reaction times.

It has been found that multisubstance mixtures, especially coating compositions, adhesives, and sealing compounds, having good properties are obtained even if at least 50, preferably at least 70 percent of the isocyanate groups of the polyisocyanate or of the mixture of the polyisocyanates are reacted with the mixture of the blocking agents (Z1) and (Z2) and the remaining isocyanate groups are reacted with a hydroxyl-containing compound or with a mixture of hydroxyl-containing compounds. Hydroxyl-containing compounds used are preferably low molecular mass aliphatic or cycloaliphatic polyols, such as neopentyl glycol, dimethylolcyclohexane, ethylene glycol, diethylene glycol, propylene glycol, 2-methyl-2-propyl-propane-1,3-diol, 2-ethyl-2-butylpropane-1,3-diol, 2,2,4-trimethylpentane-1,5-diol, and 2,2,5-trimethyl-hexane-1,6-diol, or hydroxyl-containing homopolymers or copolymers.

A suitable blocked polyisocyanate is also obtainable by mixing blocked polyisocyanates with the blocking agent (Z1) or (Z2) in a ratio such as to give a mixture in which the ratio of equivalents between the isocyanate groups blocked with (Z1) in the isocyanate groups blocked with (Z2) is between 1.0:1.0 and 9.0:1.0, preferably between 8.0:2.0 and 6.0:4.0, with particular preference between 7.5:2.5 and 6.5:3.5.

In principle, the blocked polyisocyanates may be prepared using any of the polyisocyanates known as paint polyisocyanates. It is, however, preferred to use polyisocyanates whose isocyanate groups are attached to aliphatic or cycloaliphatic radicals. Examples of such polyisocyanates are hexamethylene diisocyanate, isophorone diisocyanate (IPDI), trimethylhexamethylene diisocyanate, dicyclohexylmethane diisocyanate, 1,3-bis(2-isocyanatoprop-2-yl)benzene (TMXDI) and 1,4- and 1,3-bis(isocyanatomethyl)cyclohexanes such as 1,4- and 1,3-bis(isocyanatomethyl)cyclohexane and also adducts of these polyisocyanates with polyols, especially low molecular mass polyols, such as trimethylolpropane, for example, and polyisocyanates which are derived from these polyisocyanates and which contain isocyanurate and/or biuret groups.

Particularly preferred polyisocyanates used are hexamethylene diisocyanate or isophorone diisocyanate, polyisocyanates derived from these diisocyanates and containing isocyanurate, allophanate, uretdione, iminooxadiazinedione or biuret groups, which preferably have more than two isocyanate groups in the molecule, and also reaction products of hexamethylene diisocyanate and isophorone diisocyanate, or a mixture of hexamethylene diisocyanate and isophorone diisocyanate, with 0.3-0.5 equivalents of a low molecular mass polyol having a molecular weight of from 62 to 500, preferably from 104 to 204, in particular a triol, such as trimethylolpropane, for example.

Blocking agents (Z1) used comprise dialkyl malonates or a mixture of dialkyl malonates. Examples of dialkyl malonates which can be used are those having from 1 to 6 carbon atoms in each of the alkyl radicals, such as dimethyl malonate and diethyl malonate, for example, preference being given to the use of diethyl malonate. Blocking agents (Z2) used comprise blocking agents that are different from (Z1) and contain active methylene groups, and also oximes, and also mixtures of these blocking agents. Examples of blocking agents which may be used as blocking agents (Z2) include: methyl, ethyl, propyl, butyl, pentyl, hexyl, heptyl, octyl, nonyl, decyl or dodecyl acetoacetate, acetone oxime, methyl ethyl ketoxime, acetylacetone, formaldoxime, acetaldoxime, benzophenoxime, acetoxime and diisobutyl ketoxime. As blocking agent (Z2) it is preferred to use an alkyl acetoacetate having from 1 to 6 carbon atoms in the alkyl radical, or a mixture of such alkyl acetoacetates, or a ketoxime or mixture of ketoximes. It is particularly preferred to use ethyl acetoacetate or methyl ethyl ketoxime as blocking agent (Z2).

As crosslinkers it is also possible to use tris(alkoxycarbonylamino)triazines of the formula

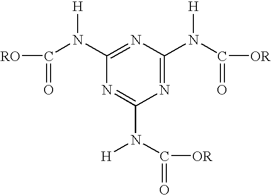

Examples of suitable tris(alkoxycarbonylamino)triazines are described in the patents U.S. Pat. No. 4,939,213, U.S. Pat. No. 5,084,541, and EP-A-0 624 577. Use is made in particular of the tris(methoxy-, tris(butoxy- and/or tris(2-ethylhexoxycarbonylamino)triazines.

Of advantage are the methyl butyl mixed esters, the butyl-2-ethyl hexyl mixed esters, and the butyl esters. They have the advantage over the straight methyl ester of better solubility in polymer melts, and also have less of a tendency to crystallize out.

It is also possible to use amino resins, examples being melamine resins. In this context it is possible to use any amino resin suitable for transparent topcoats or clearcoats, or a mixture of such amino resins. Particularly suitable amino resins are the customary and known examples some of whose methylol and/or methoxy methyl groups have been defunctionalized by means of carbamate or allophanate groups. Crosslinking agents of this kind are described in the patents U.S. Pat. No. 4,710,542 and EP-B-0 245 700 and also in the article by B. Singh and coworkers entitled “Carbamylmethylated Melamines, Novel Crosslinkers for the Coatings Industry” in Advanced Organic Coatings Science and Technology Series, 1991, volume 13, pages 193 to 207.

Examples of suitable beta-hydroxyalkylamides are N,N,N′,N′-tetrakis(2-hydroxyethyl)adipamide and N,N,N′,N′-tetrakis(2-hydroxypropyl)adipamide.

In the case of the multicomponent systems, especially the two-component systems, the crosslinking agent used comprises at least one nonblocked or part-blocked polyisocyanate, in solution if desired in one or more organic solvents. Additionally, however, it is also possible to use at least one of the above-described blocked polyisocyanates as well.

The nonblocked polyisocyanates comprise any desired organic polyisocyanates, especially paint polyisocyanates, having free-isocyanate groups attached to aliphatic, cycloaliphatic, araliphatic and/or aromatic moieties. It is also possible to use the part-blocked polyisocyanates of the German patent DE-A-196 09 617. Preference is given to the use of polyisocyanates having from 2 to 5 isocyanate groups per molecule and having viscosities of from 100 to 2 000 mPa.s (at 23° C.). If desired, small amounts of organic solvent, preferably from 1 to 25% by weight based on polyisocyanate alone, may be added to the polyisocyanates in order to improve the ease with which they are incorporated and, if appropriate, to lower the viscosity of the polyisocyanate to a level within the abovementioned ranges.

Examples of suitable solvents for the polyisocyanates are ethoxyethyl propionate, butyl acetate, and the like. Examples of suitable isocyanates are described in “Methoden der organischen Chemiel”, Houben-Weyl, volume 14/2, 4th edition, Georg Thieme Verlag, Stuttgart, 1963, pages 61 to 70, and by W. Siefken, Liebigs Annalen der Chemie, volume 562, pages 75 to 136.

Further examples of suitable polyisocyanates are polyurethane prepolymers which contain isocyanate groups, may be prepared by reacting polyols with an excess of polyisocyanates, and are preferably of low viscosity. It is also possible to use polyisocyanates containing isocyanurate, biuret, allophanate, iminooxadiazinedione, urethane, urea and/or uretdione groups. Polyisocyanates containing urethane groups, for example, are obtained by reacting some of the isocyanate groups with polyols, such as trimethylolpropane and glycerol, for example. It is preferred to use aliphatic or cycloaliphatic polyisocyanates, especially hexamethylene diisocyanate, dimerized and trimerized hexamethylene diisocyanate, isophorone diisocyanate, 2-isocyanatopropylcyclohexyl isocyanate, dicyclohexylmethane-2,4′-diisocyanate or dicyclohexylmethane-4,4′-diisocyanate, or mixtures of these polyisocyanates.

Very particular preference is given to the use of mixtures of polyisocyanates which contain uretdione and/or isocyanurate and/or allophanate groups and which are based on hexamethylene diisocyanate, these polyisocyanates being formed for instance by catalytic oligomerization of hexamethylene diisocyanate using appropriate catalysts. The polyisocyanate component may, moreover, comprise any desired mixtures of the free polyisocyanates exemplified.

Furthermore, the coating compositions, adhesives, and sealing compounds of the invention may comprise UV absorbers; free-radical scavengers; crosslinking catalysts, especially organometallic compounds, preferably organotin and/or organobismuth compounds or tertiary amines; rheology agents, especially those known from the patents WO 94/22968, EP-A-0 276 501, EP-A-0 249 201, and WO 97/12945; pigments and fillers of all kinds, examples being color pigments such as azo pigments, phthalocyanine pigments, carbonyl pigments, dioxazine pigments, titanium dioxide, pigmentary carbon black, iron oxides or chromium and/or cobalt oxides, effect pigments such as metal flake pigments, especially aluminum flake pigments, and pearlescent pigments or fillers such as chalk, calcium sulfate, barium sulfate, silicates such as talc or kaolin, silicas, oxides such as aluminum hydroxide or magnesium hydroxide or organic fillers such as textile fibers, cellulose fibers, polyethylene fibers or wood flour; slip additives; polymerization inhibitors; defoamers; leveling agents or film-forming auxiliaries, e.g., cellulose derivatives; or other additives commonly used in coating compositions, adhesives, or sealing compounds.

These additives are customarily used in an amount of up to 15% by weight, preferably from 2 to 9% by weight, based on the weight of the respective coating compositions, adhesives, and sealing compounds of the invention without pigments and without fillers.

In accordance with the invention it is of advantage to select in particular the coating composition of the invention such that the cured coating composition, i.e., the coating of the invention, has a storage modulus E′ in the rubber-elastic range of at least 10^{7.6} Pa, preferably at least 10^{8.0} Pa, with particular preference at least 10^{8.3} Pa, and a loss factor at 20° C. of not more than 0.10, preferably not more than 0.06, the storage modulus E′ and the loss factor tanδ having been measured by dynamic mechanical thermoanalysis on homogeneous free films having a film thickness of 40±10 μm. The loss factor tanδ is defined as the quotient of the loss modulus E″ and the storage modulus E′.

Dynamic mechanical thermoanalysis is a widely known method of measuring the viscoelastic properties of coatings and is described, for example, in Murayama, T., Dynamic Mechanical Analysis of Polymeric Material, Elsevier, New York, 1978 and Loren W. Hill, Journal of Coatings Technology, vol. 64, No. 808, May 1991, pages 31 to 33.

The measurements can be made using, for example, the MK II, MK III or MK IV instruments from Rheometrics Scientific.

The storage modulus E′ and the loss factor tanδ are measured on homogeneous free films. The free films are prepared in a known way by applying and curing the coating composition of the invention on and to substrates to which the coating composition does not adhere. Examples of suitable substrates include glass, Teflon, and, in particular, polypropylene. Polypropylene features the advantage of ready availability and is therefore normally used as the substrate material.

The film thickness of the free films used for the measurement is generally 40±10 μm.

The specific selection of the coating compositions of the invention by way of the value of the storage modulus in the rubber elastic range and the loss factor at 20° C. of the cured coating compositions makes it easy to provide coating compositions having the desired profile of the properties comprising good scratch resistance coupled with effective polishability, chemical resistance, moisture resistance; and weathering stability, since both variables may be determined by means of simple DMTA measurements. Moreover, the resultant coatings of the invention have a high gloss and an acid and base resistance comparable with the corresponding values for conventional coatings cured thermally.

The coating compositions, adhesives, and sealing compounds of the invention may exist and be used in the form of sheets, powders, aqueous powder slurries, solvent-free liquids or melts, as solutions or dispersions in aqueous media, or on a conventional basis, i.e., as a solution in organic solvents customary and known in the field of the coating compositions, adhesives, and sealing compounds. The properties which the constituents of the coating compositions, adhesives, and sealing compounds of the invention must have in order to be suitable for the respective use and application form are well known to the skilled worker. Accordingly, he or she will use, for example, solid binders (A) for use in accordance with the invention to prepare powders, liquid binders (A) to prepare solvent-free liquids, water-soluble or water-dispersible binders (A) to prepare aqueous solutions or dispersions, or binders (A) of appropriate solubility for solutions in organic solvents.

The preparation of the coating compositions, adhesives, and sealing compounds of the invention has no special features in terms of its methodology; rather, the customary methods are employed, such as combining the individual constituents and mixing them with stirring. The preparation of the multisubstance mixtures of the invention comprising two or more components takes place likewise by means of stirring or dispersion using the apparatus commonly employed—for example, by means of dissolvers or by means of customary two-component or multicomponent metering and mixing units. The individual components are stored separately until they are used as intended.

The coating composition of the invention is used in particular to produce coated moldings, composites or complex components, especially vehicle bodies, which comprise or consist of sheets, glass, wood, paper and/or metal, by application of the coating composition, by coil coating for example, to the corresponding moldings, composites or complex components and by curing of the resultant coating.

The coating composition of the invention is preferably used to produce single-coat or multicoat systems, and with particular preference is used to produce topcoats. However, it may also be intended for the production of a clearcoat material which is to be applied over a basecoat film; for example, of a clearcoat or a multicoat system produced by the wet-on-wet technique. Furthermore, it may also be used as a primer, a primer-surfacer, or underbody protection. The plastics or the other substrates may of course also be coated directly with the clearcoat or with the topcoat.

The coating compositions of the invention may be used for both the OEM finishing and the refinish of vehicle bodies, especially automobile bodies, including mounted plastic parts.

The adhesive of the invention is used to produce bonded composites which consist of or comprise sheets, plastics, glass, wood, paper and/or metal, by application and, if desired, initial curing of the adhesive to and on, respectively, the surface(s) of a sheet or of a molding consisting of or comprising plastic; glass, wood, paper and/or metal that are to be bonded, and/or to the surface(s) of the part to which it is to be bonded, after which the surfaces to be bonded in question are brought into contact and, subsequently, the adhesive is cured to completion.

The coating composition of the invention and the adhesive of the invention are generally applied with the aid of customary methods, for example, by spraying, knifecoating, dipping or brushing.

The sealing compound of the invention is used for hermetically sealing the joints in composites and complex components, especially vehicle bodies, which are composed of different moldings and composites. For this purpose, the sealing compound of the invention is introduced into the joints, by spraying or pouring, for instance, and is thermally cured together, if appropriate, with the coating compositions and/or adhesives that are likewise used.

The coating compositions, adhesives, or sealing compounds of the invention are preferably cured at temperatures from room temperature up to 240° C. Particular preference is given to temperatures between 60 and 180° C. In specific embodiments of the coating compositions of the invention it is also possible to employ lower curing temperatures of from 60 to 160° C.

Moldings, composites and complex components which consist of or comprise sheets, plastics, glass, wood, paper and/or metal and comprise at least one coat of the cured binder, at least one film of the cured adhesive and/or at least one joint sealed with a cured sealing compound of the invention have distinct advantages over conventional moldings, composites and components with regard to heat stability, light stability, scratch resistance, and weathering stability, resulting overall in a longer service life.

### EXAMPLES

### Preparation Example 1

The Preparation of a Polyacrylate (A) for Use in Accordance with the Invention

A laboratory reactor having a useful volume of 4 l, equipped with a stirrer, two dropping funnels for the monomer feed and initiator feed, a nitrogen inlet pipe, a thermometer, and a reflux condenser was charged with 757.2 g of solvent naphtha and this initial charge was heated to 140° C. The initiator feed, consisting of 78.9 g of solvent naphtha and 38.1 g of tert-butyl peroxy-2-ethylhexanoate, was metered in at a uniform rate over the course of four hours. The monomer feed, consisting of 88.6 g of ethylhexyl acrylate, 258 g of hydroxyethyl methacrylate, 573.3 g of methylpropane-1,3-diol monoacrylate and 191.1 g of styrene, was metered in at a uniform rate over the course of 3.5 hours. The monomer feed was commenced 15 minutes after the initiator feed. During the copolymerization, the temperature was held at 140° C. Following the addition, polymerization was continued at 140° C. for two hours. The resulting polyacrylate solution had a solids content of 70%. Thereafter the temperature of the solution was lowered to 120° C. and its solids content was adjusted to 65% using 214.8 g of solvent naphtha. The viscosity (original) was 25.2 dPas.

The resulting polyacrylate resin for use in accordance with the invention had a (theoretical) hydroxyl number of 175 mg KOH/g, a number-average molecular weight Mn of 3 973, a weight-average molecular weight Mw of 13 600, and a polydispersity Mw/Mn of 3.42.

### Preparation Example 2

Preparation of a Conventional Polyacrylate Resin (Comparative Experiment)

Preparation example 1 was repeated but using 758.4 g of solvent naphtha as initial charge, 77.4 g of solvent naphtha and 37.8 g of tert-butyl peroxy-2-hexanoate as the initiator feed, and 889.5 g of ethylhexyl acrylate, 258 g of hydroxyethyl meth-acrylate, 573.9 g of 4-hydroxybutyl acrylate and 190.5 g of styrene as the monomer feed.

The resulting polyacrylate resin solution had a solids content of 63.7% and a viscosity (original) of 16.8 dPas.

The resulting polyacrylate resin had a number-average molecular weight Mn of 3 908, a weight-average molecular weight Mw of 10 170, and a polydispersity Mw/Mn of 2.6.

### Example and Comparative Experiment

Preparation of an Inventive (Example) and of a Noninventive (Comparative Experiment) Coating Composition in the Form of Two-Component Clearcoat Materials

77.5 parts by weight of each of the above-described polyacrylate resin solutions (65% solids content; one hour at 130° C.), 6.5 parts by weight of butyl acetate, 2 parts by weight of xylene, 4 parts by weight of butyl glycol acetate, 4.5 parts by weight of butyl glycolate and 0.004 part by weight of dibutyltin dilaurate were mixed with 53 parts by weight of Desmodur^{R} Z4470 (commercial IPDI trimer from Bayer AG) and the mixture was adjusted with butyl acetate to a viscosity of 30 seconds in the DIN 4 cup.

Both the resulting inventive coating composition and the noninventive composition were applied as clearcoat materials with a film thickness of 40-45 μm to test panels which had on them an electrocoat with a thickness of 18-22 μm, a primer-surfacer coat with a thickness of 35-40 μm and a black basecoat with a thickness of 12-15 μm, situated above one another, and the clearcoats were crosslinked at 80° C. Following the application, the panels were stored at room temperature for at least 2 weeks. Then the scratch resistance and the chemical resistance of the inventive and of the noninventive coating were determined.

The Scratch Resistance by the Brush Test

The scratch resistance of the inventive clearcoat on the inventive test panels and of the noninventive clearcoat on the noninventive test panels was assessed as follows with the aid of the BASF brush test described in FIG. 2 of page 28 of the article by P. Betz and A. Bartelt, Progress in Organic Coatings, 22 (1993), pages 27-37, albeit with modification in respect of the weight used (2 000 g instead of the 280 g specified therein):

In the test, the film surface was damaged using a weighted mesh fabric. The mesh fabric and the film surface were wetted generously with a laundry detergent solution. The test panel was moved forward and backward in reciprocal movements under the mesh fabric by means of a motor drive.

The test body was an eraser (4.5×2.0 cm, broad side perpendicular to the direction of scratching) lined with nylon mesh fabric (No. 11, 31 μm mesh size, Tg 50° C.). The applied weight was 2 000 g.

Prior to each test the mesh fabric was replaced, with the running direction of the fabric meshes parallel to the direction of scratching. Using a pipette, about 1 ml of a freshly stirred 0.25% strength Persil solution was applied in front of the eraser. The rotary speed of the motor was set so that 80 double strokes were performed within a period of 80 s. Following the test, the remaining washing liquid was rinsed off with cold tap water and the test panels were blown dry using compressed air. Measurements were made of the gloss (20°) to DIN 67530 before and after damage (direction of measurement perpendicular to the direction of scratching).

In the brush test, the scratch resistance of the clearcoats was of a comparable extent, as manifested by the small reduction in their gloss (dgloss) after stressing.

The Chemical Resistance by the BART Test

The BART (BASF ACID RESISTANCE TEST) was used to determine the resistance of film surfaces to acids, alkalis, and water droplets. After baking, the coating was subjected to further temperature stresses in a gradient oven (30 min at 40° C., 50° C., 60° C., and 70° C.). Beforehand the test substances (1%, 10%, and 36% sulfuric acid; 6% sulfural acid; 10% hydrochloric acid; 5% sodium hydroxide solution; DI (i.e., deionized) water −1, 2, 3 or 4 drops in each case) had been applied in a defined manner using a volumetric pipette. After the substances had been allowed to act, they were removed under running water and the damage was assessed visually after 24 h in accordance with a predetermined scale:

| Rating | Appearance |
|---|---|
| 0 | no defect |
| 1 | slight marking |
| 2 | marking/matting/no softening |
| 3 | marking/matting/color change/softening |
| 4 | cracks/incipient through-etching |
| 5 | clearcoat removed |

Each individual mark (spot) was evaluated and the result was recorded in an appropriate form (e.g., sums of the ratings for one temperature). The table gives an overview of the results obtained.

Table:

The Results of the BART Test

| Temperature | Example | | | | Comparative experiment | | | |
|---|---|---|---|---|---|---|---|---|
| (° C.) | 50 | 60 | 70 | 80 | 50 | 60 | 70 | 80 |
| 1% H₂SO₄ | 0 | 1 | 1 | 1 | 0 | 0.5 | 1.5 | 2.5 |
| 10% H₂SO₄ | 0 | 0 | 1 | 1.5 | 0 | 0 | 1 | 2 |
| 36% H₂SO₄ | 0 | 0 | 1 | 2 | 1 | 1 | 1.5 | 3 |
| 10% HCl | 0 | 1 | 1 | 1.5 | 0 | 0.5 | 1 | 2 |
| 5% H₂SO₃ | 0 | 0 | 1 | 2 | 0 | 0.5 | 1.5 | 2 |
| 5% NaOH | 0 | 0 | 0 | 1 | 0 | 0 | 1 | 4.5 |
| DI water 1 | 0 | 0 | 0.5 | 1 | 0 | 0.5 | 1 | 1 |
| DI water 2 | 0 | 0 | 0.5 | 1 | 0 | 0.5 | 1.5 | 1 |
| DI water 3 | 0 | 0 | 0 | 0.5 | 0 | 0.5 | 1.5 | 1 |
| DI water 4 | 0 | 0 | 0 | 0.5 | 1 | 0.5 | 1.5 | 1 |
| Sum | 0 | 0.5 | 1.0 | 3 | 1 | 2 | 5.5 | 4 |
| Water | | | | | | | | |
| Sum | 0 | 2 | 5 | 10 | 1 | 2.5 | 7.5 | 16 |
| Acid | | | | | | | | |

The results of the table demonstrate the outstanding chemical resistance of the clearcoat of the invention in combination with its high scratch resistance.

Acid Test in the Gradient Oven

The acid resistance of the clearcoat of the invention was underscored still further by the acid test in the gradient oven. In this test, 1% sulfuric acid was employed. Whereas the clearcoat of the invention underwent incipient etching only at 52° C., the noninventive clearcoat was damaged at just 38° C.

Fischerscope Hardness

The micropenetration hardness of the inventive and noninventive clearcoats was found in the Fischerscope to be 160 and 126, respectively, thereby demonstrating the superior hardness and scratch resistance of the inventive clearcoat.

1. A method comprising:
A. applying to a substrate a composition comprising at least one of
i) a homopolymer of methylpropane-1,3-diol mono(meth)acrylate, and
ii) a copolymer comprising a reaction product of methylpropane-1,3-diol mono(meth)acrylate and at least one monomer copolymerizable with methylpropane-1,3-diol mono(meth)acrylate; and
B. curing the composition by at least one of:
i) oxidative curing, and
ii) thermal curing.

2. The method of claim 1, wherein the composition is a one-component composition.

3. The method of claim 1, wherein the composition is a two-component composition.

4. The method of claim 1, wherein the composition is a multi-component composition.

5. The method of claim 1, wherein the composition is one of a coating composition, an adhesive composition, and a sealing composition.

6. The method of claim 1, wherein the composition is one of a furniture coating, an industrial coating, an automotive OEM coating, and an automotive refinish coating.

7. The method of claim 1, wherein the composition further comprises at least one crosslinking agent that contains functional groups that are reactive with hydroxyl groups.

8. The method of claim 1, wherein the composition further comprises a pigment.

9. The method of claim 1, wherein the composition further comprises a reactive diluent that contains hydroxyl groups.

10. The method of claim 1, wherein the composition is prepared by a process comprising free-radical (co)polymerizing in a reaction medium the methylpropane-1,3-diol mono(meth)acrylate and optionally the at least one monomer copolymerizable with methylpropane-1,3-diol mono(meth)acrylate, wherein the reaction medium comprises a reactive diluent for at least one of a thermally curable coating composition, an adhesive composition, and a sealing compound.

11. The method of claim 1, wherein the composition is prepared by a process comprising free-radical (co)polymerizing in a reaction medium the methylpropane-1,3-diol mono(meth)acrylate and optionally the at least one monomer copolymerizable with methylpropane-1,3-diol mono(meth)acrylate in a Taylor reactor having an external reactor wall located within which there is a concentrically or eccentrically disposed rotor, a reactor floor, and a reactor lid, which together define an annular reactor volume, at least one means for metered addition of reactants, and a means for discharge ,of product, wherein at least one of the reactor wall and the rotor is geometrically designed in such a way that the conditions for Taylor flow are met over substantially the entire reactor length in the reactor volume, in such a way that the annular gap broadens in the direction of flow traversal.

12. The method of claim 11, wherein the reaction medium comprises a reactive diluent for thermally curable compositions.
